(19) United States
(12) Patent Application Publication
(10) Pub. No.: US 2007/0033822 A1
(43) Pub. Date: Feb. 15, 2007

(54) Drywall tool

(76) Inventor: Bryan Leo Reck, Collingwood (CA)

Correspondence Address: RATNERPRESTIA, P O BOX 980, VALLEY FORGE, PA, 19482-0980, US

(21) Appl. No.: 11/199,645

(22) Filed: Aug. 9, 2005

(51) Int. Cl. B43L 7/00

(52) U.S. Cl. 33/566

(57) ABSTRACT

A tool for use in cutting drywall is provided. The tool is comprised of a plate with at least one indentation it the top edge of the plate. The tool is placed flush against a piece of drywall so that the drywall may be cut with indentations matching the at least one indentation in the top edge of the plate. In a further embodiment of the invention, a plurality of the plates are joined together. A method for cutting at least one indentation in a plate comprising placing the plate against drywall and cutting the drywall to match the at least one indentation.

### FIELD OF THE INVENTION

The present invention relates to a tool for cutting drywall.

### BACKGROUND OF THE INVENTION

Drywall is an essential component in conventional building construction. The skeleton of an interior room in a building includes vertical corner posts which bookend upright supports, known as studs. The studs constitute the structural support for the non-load bearing walls in a building. Sheets of drywall are attached to the opposing sides of studs and extend from floor to ceiling.

Vertical corner posts are normally metallic and recently metal studs have gained acceptance amongst builders. As a result, these components of a building's construction are fire-resistant. The drywall is also fire-resistant, which helps to contain a fire within a single room. To ensure that the fire is contained, the boundaries between the ceilings and the walls must be well sealed.

Sealing the boundary between a wall and the ceiling of a room is particularly challenging when the ceiling is fluted decking. Normally, concrete is poured onto fluted decking to form the floor above. The decking itself is steel with downwardly facing, concave channels and may be left exposed for cosmetic reasons. The channels are also known as flutes.

The decking extends along the length of a building such that the walls of individual rooms meet the decking transversely. Where the walls extend along the length of a channel, there will be little potential for gaps at the meeting points. However, where the plane of the wall is transverse from the planes of the channels, there will be gaps where the walls meet the decking unless the drywall is cut or shaped to fit within the channels.

Recently there has been a trend toward attempting to prevent the spread of fire beyond interior walls by adding strict provisions to fire code regulations. Fire-resistant insulation is packed in the flute openings between rooms to prevent the spread of flames. If the gap between the drywall and the roof flutes is not properly sealed, expensive fire retardant spray must be applied to the insulation. Even after fire-retardant spray is applied, there are significant risks. When a fire is burning in a room, the smoke generated by the fire creates pressure. This pressure has been known to force the insulation from its placement between the walls, thus opening a passage for the spread of flames.

Therefore, to secure the insulation within the cavity between the walls, fire code regulations now require the precise cutting of drywall so that its top edge fits within the deck flutes. Hand cutting the top edge of the drywall can be labour intensive and may add significantly to the costs of construction. Furthermore, hand cutting frequently results in the drywall fitting poorly at the border of the deck flutes and the interior walls. Extensive caulking or the addition of fire tape at the gap between the drywall and the ceiling will then be necessary.

### SUMMARY OF THE INVENTION

In view of the deficiencies of the prior art, a tool is provided for use in cutting varied lengths of drywall sheets to match the profile of a surface against which the drywall is to be mounted.

Accordingly, in one aspect of the invention, an apparatus is comprised of a plate with a bottom edge, a top edge, a first side edge and a second side edge. The plate has at least one indentation on its top edge between the first side edge and the second side edge. The apparatus can be placed flush against drywall such that the drywall may be cut with indentations matching the at least one indentation in the top edge of the plate.

In a further aspect of the invention, the apparatus is comprised of a plurality of plates joined together. Each of the plates has a bottom edge, a top edge, a first side edge and a second side edge. Each of the plates also has at least one indentation on its top edge between the first side edge and the second side edge. The apparatus can be placed flush against drywall such that the drywall may be cut with indentations matching the at least one indentation in the top edge of each of the plates.

A further aspect of the invention is a method for cutting drywall using a plate with at least one indentation in a top edge of the plate and comprising the steps of placing the plate against the drywall and cutting the drywall to match the at least one indentation.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following Figures:

FIG. 1 is a perspective view of a first exemplary embodiment of the invention with one plate;

FIG. 2 is a perspective view of a second exemplary embodiment of the invention with two plates in an open position;

FIG. 3 is a perspective view of the second embodiment of the invention with two plates in a closed position;

FIG. 4a is a cross-sectional view of the second embodiment of the invention, taken along line 4a-4a of FIG. 2, with a fastener in a tightened position;

FIG. 4b is a cross-sectional view of the second embodiment of the invention, taken along line 4a-4a of FIG. 2, with the fastener in a loosened position;

FIG. 5 is a perspective view of the second embodiment of the invention with two plates apart from one another;

FIG. 6 is a perspective view of a third exemplary embodiment of the invention;

FIG. 7 is a top view of the third embodiment of the invention with a fastener in a tightened position; and

FIG. 8 is a perspective view of the second embodiment of the invention in situ relative to a partially cut sheet of drywall below a roof with deck flutes.

### DETAILED DESCRIPTION

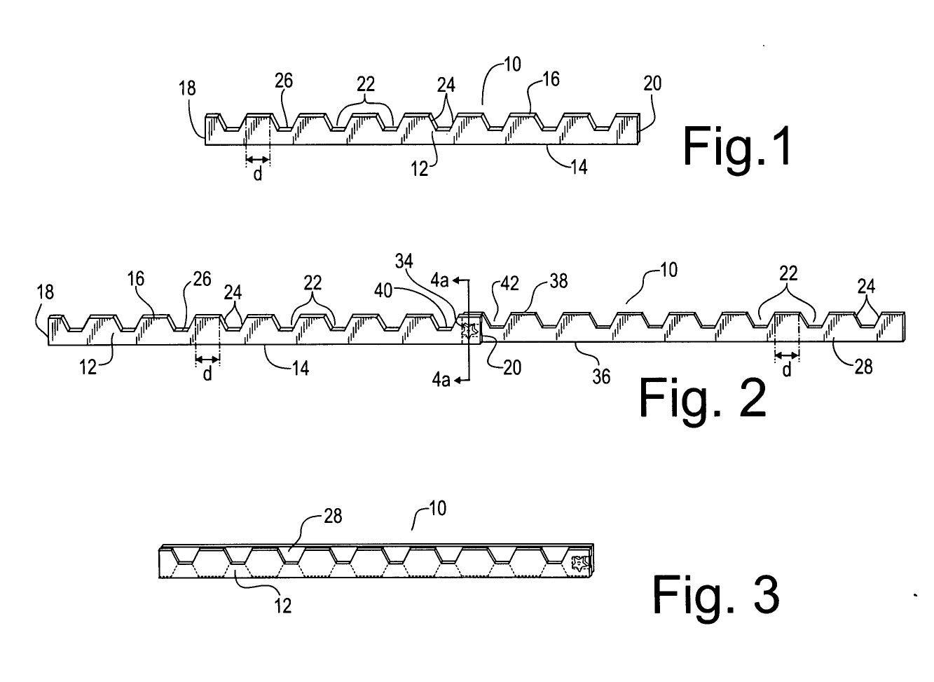

A drywall tool 10 for cutting drywall is shown in FIG. 1. The drywall tool 10 is generally comprised of a plate 12. The plate 12 is desirably substantially flat. Furthermore, the plate 12 may be comprised of any solid material. In one exemplary embodiment of the apparatus, the plate is metallic. A light yet durable metal such as aluminum is desirable. The plate 12 may be constructed in a variety of dimensions to suit the application. One configuration found suitable for cutting drywall for abutting ceiling deck flutes is for the plate 12 to be one quarter inch thick, three inches high and fifty inches long.

The plate 12 has a bottom edge 14, a top edge 16, a first side edge 18 and a second side edge 20. The bottom edge 14 is parallel to the top edge 16 of the plate 12. The first side edge 18 and the second side edge 20 are parallel to one another and perpendicular to bottom edge 14 and top edge 16 of the plate 12. The plate 12 has indentations 22 in the top edge 14. In one exemplary embodiment of the drywall tool 10, each of the indentations 22 has opposing sloped edges 24. The sloped edges 24 meet at an indentation floor 26. Each indentation floor 26 is parallel to the bottom edge 14 and the top edge 16 of the plate 12. Furthermore, each indentation floor 26 is equidistant from the bottom edge 14 of the plate 12.

In the configuration of the drywall tool 10 shown and discussed herein, the indentations 22 are spaced three inches apart and the indentation floor 26 is one and one half inches long. However, as the skilled person in the art will appreciate, the spacing of the indentations 22 and the length of the indentation floor 26 may vary. The plate 12 may be manufactured such that the indentations 22 may match any profile against which the drywall tool 10 is placed. Furthermore, the plate 12 may be manufactured such that the drywall tool 10 fits snugly against roof flutes of any dimension.

In a further embodiment of the invention, shown in an open position in FIG. 2, the plate 12 is joined to a second plate 28. The second plate 28 has dimensions identical to the dimensions of the plate 12 and has a first side edge 34, a bottom edge 36 and a top edge 38.

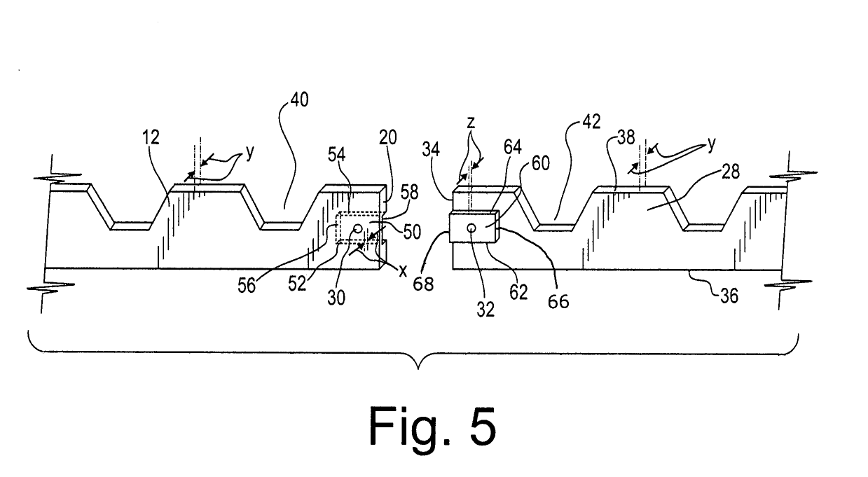

In this embodiment of the invention, the plate 12 has a first aperture 30 and the second plate 28 has a second aperture 32 (as best seen in FIG. 5). Desirably, the first aperture 30 extends through the entire thickness of plate 12 and the second aperture 32 extends through the entire thickness of the second plate 28. However, one of the first aperture 30 and the second aperture 32 may not extend through the entire thickness of the corresponding plate. In this circumstance, the aperture that does not extend through the entire plate is threaded to accept a threaded fastener.

It will be appreciated by those skilled in the art that more than two of plates 12, 28 can be joined together to form a length of tool 10 suitable for cutting drywall. The embodiment of the two plates 12, 28 will be illustrated and discussed for convenience.

As illustrated, the first aperture 30 is proximate to the second side edge 20 of the plate 12 and the second aperture 32 is proximate to the first side edge 34 of the second plate 28. Furthermore, the distance between the first aperture 30 and the second side edge 20 and the distance between the second aperture 32 and the first side edge 34 are such that when the first aperture 30 is lined up with the second aperture 32, the edges 20, 34 overlap such that the resulting distance between an indentation 40 closest to the second side edge 20 and an indentation 42 closest to the first side edge 34 is equal to the distance “d” between indentations 22 in each of the plates 12, 28.

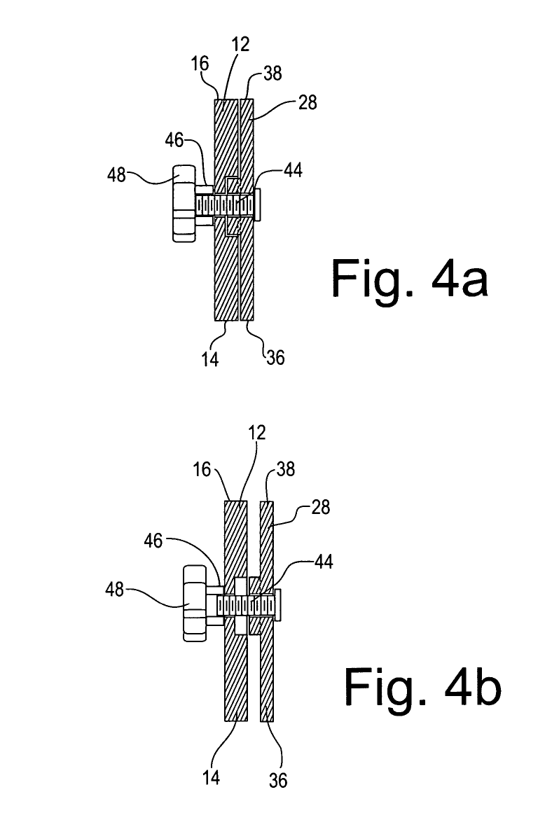

As shown in FIG. 4a, when the first aperture 30 is lined up with second aperture 32, a fastener 44 may be placed through the first aperture 30 and the second aperture 32 to releasably join the plate 12 and the second plate 28. The fastener 44 may be a peg, a bolt, a screw or any other elongated device sized to extend through the first aperture 30 and the second aperture 32. The fastener 44 is threaded and releasably secured in place by a nut 46. Desirably, the nut 46 has head 48 that may be easily gripped by the user of the drywall tool 10. Conventional nuts, including wingnuts, may also be used.

Alternatively, if one of the first aperture 30 or the second aperture 32 does not extend through the plate 12 or the second plate 28, respectively, that aperture is threaded. The fastener 44 is sized to extend through the non-threaded aperture and engage the threaded aperture in order to releasably secure the fastener.

A recess 50 in the plate 12 surrounds the first aperture 30, as shown in FIG. 5. In one exemplary embodiment, the recess 50 has a bottom 52, a top 54, a first side 56 and a second side 58. The bottom 52 is parallel to the top 54 and the bottom 52 and the top 54 are perpendicular to the first side 56 and the second side 58 such that the recess 50 is square shaped or rectangular. Furthermore, the bottom 52 and the top 54 of the recess 50 are both parallel to the bottom edge 14 and the top edge 16 of the plate 12. The depth x of recess 50 is equal to half of the thickness y of the plate 12.

A flange 60 surrounds the second aperture 32. In one exemplary embodiment, the flange 60 has a bottom 62, a top 64, a first side 66 and a second side 68. The bottom 62 is parallel to the top 64 and the bottom 62 and the top 64 are perpendicular to the first side 66 and the second side 68 such that the flange 60 is square shaped or rectangular. Furthermore, the bottom 62 and the top 64 of the flange 60 are both parallel to the bottom edge 36 and the top edge 38 of the second plate 28. The thickness z of the flange 60 is equal to half of the thickness y of the second plate 28.

The recess 50 and the flange 60 are oriented and sized such that when the first aperture 30 is lined up with the second aperture 32 the recess 50 receives the flange 60. Furthermore, the height and width of the flange 60 are each only slightly less than the height and width of the recess 50, respectively, such that the flange 60 fits tightly within the recess 50.

In a further embodiment (not shown) the recess 50 and the flange 60 are both circular.

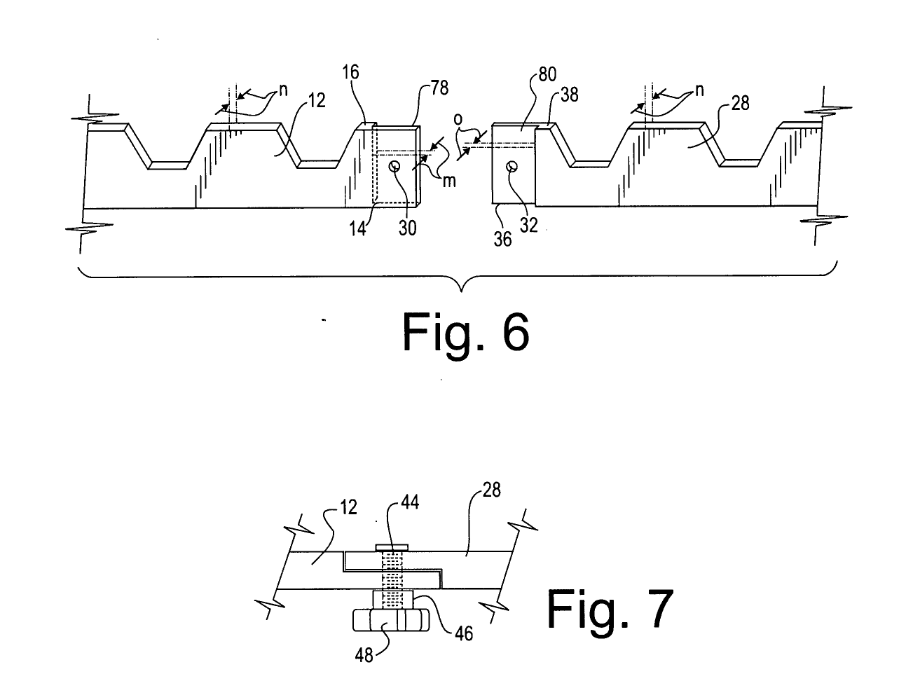

In a further alternative embodiment of the invention shown in FIGS. 6 and 7, the plate 12 has a cutout 78 and the second plate 28 has a second cutout 80. The depth m of the cutout 78 is equal to half the thickness n of the plate 12. The depth o of the second cutout 80 is equal to half of the thickness n of the second plate 28. The cutout 78 surrounds the first aperture 30 and extends between the bottom edge 14 and the top edge 16 of the plate 12. Similarly, second cutout 80 surrounds the second aperture 32 and extends between the bottom edge 36 and the top edge 38 of the second plate 28. The cutout 78 and the second cutout 80 are mirror images of one another.

The drywall tool 10 comprised of plate 12 and second plate 28 has an open position, shown in FIG. 2 and a closed position, shown in FIG. 3. To manipulate the drywall tool 10 between these two positions, the nut 46 is loosened by rotating the nut 46 about the fastener 44. The plate 12 is separated from the second plate 28 such that the flange 60 is no longer nested within the recess 50, as shown in FIG. 4b. The plate 12 or the second plate 28 may then be rotated one hundred and eighty degrees about the fastener 44 to the open position or the closed position, the plates may be pressed together such that the flange 60 nests within the recess 50 as shown in FIG. 4a and the nut 46 may be tightened.

Alternatively, if the recess 50 and the flange 60 are circular, the user does not have to separate the plate 12 from the second plate 28 before rotating the plate 12 or the second plate 28 about the other.

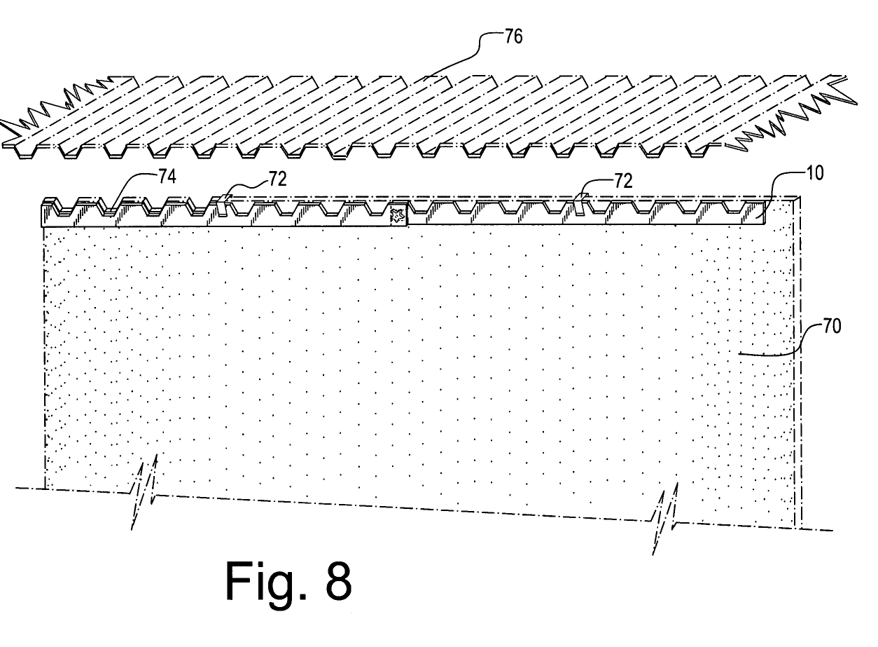

When using the drywall tool 10 for cutting, the drywall tool 10 is placed against a piece of drywall 70. The length of the drywall 70 to be cut will determine whether the tool 10 will comprise a single plate 12, a plate 12 and a second plate 28, or three or more properly oriented plates. The drywall tool 10 may be releasably attached to a piece of drywall by at least one securing means 72, as shown in FIG. 8. The securing means 72 may be a clamp or a clip or anything suitable to hold the tool 10 flush against the drywall 70. When the flange 60 is tightly nested in the recess 50 and the drywall tool 10 is in the open position, each of the indentation floors 26 of the plate 12 and the second plate 28 will be equidistant from the top edge of the drywall 70. The drywall 70 is then cut to the shape of the drywall tool 10 such that a resulting profile of a top edge 74 of the drywall 70 fits within fluted roof decking 76. Alternatively, an outline of the drywalling tool 10 may be traced upon the drywall 70 and the drywall tool 10 may be detached from the drywall 70 before cutting the drywall 70 along the tracings.

Numerous modifications may be made to the embodiments as described above without departing from the scope of the invention, which is described by the claims.

I claim:

1. An apparatus for use in cutting drywall comprising:
a plate with a bottom edge, a top edge, a first side edge and a second side edge;
at least one indentation on said top edge of the plate between the first side edge and the second side edge wherein the apparatus can be placed adjacent the drywall such that the drywall may be cut with indentations matching said at least one indentation.

2. The apparatus of claim 1 wherein said at least one indentation is spaced, shaped and sized to match a profile of a surface against which the drywall is to be mounted.

3. The apparatus of claim 2 wherein the at least one indentation is spaced, shaped and sized to match roof deck flutes.

4. The apparatus of claim 1 further comprising a securing means for releasably attaching the apparatus to the drywall.

5. The apparatus of claim 4 wherein the securing means is a clamp.

6. The apparatus of claim 4 wherein the securing means is a clip.

7. The apparatus of claim 1 wherein the plate is metallic.

8. The apparatus of claim 1 wherein the apparatus is comprised of a plurality of said plates joined together.

9. The apparatus of claim 8 wherein each plate comprises an aperture proximate to at least one of the first side edge and the second side edge and the apparatus further comprises removable fasteners for attaching adjacent plates.

10. The apparatus of claim 8 further comprising a recess proximate to the first side edge of a first plate and a flange proximate to the second side edge of a second plate such that the recess receives the flange and the apertures meet when the recess receives the flange.

11. The apparatus of claim 10 wherein the aperture of the first plate is in the recess and the aperture of the second plate is in the flange.

12. The apparatus of claim 10 wherein the recess and the flange have straight edges.

13. The apparatus of claim 12 wherein the recess and the flange are rectangular.

14. The apparatus of claim 1 wherein the second side edge of the apparatus is placed flush against the drywall.

15. A plurality of plates joined together for use in cutting drywall, each of said plates comprising:
a plate with a bottom edge, a top edge, a first side edge and a second side edge;
at least one indentation on said top edge of the plate between the first side edge and the second side edge wherein the apparatus can be placed flush against the drywall such that the drywall may be cut with indentations matching said at least one indentation.

16. A method for cutting drywall using a plate with at least one indentation in a top edge the plate comprising:
placing the plate against the drywall;
cutting the drywall to match the at least one indentation.

17. The method of claim 16 further comprising releasably attaching the plate to the drywall.

18. The method of claim 16 further comprising marking the drywall with tracings after the plate is placed against the drywall and cutting the tracings.
